(19) United States
(12) Patent Application Publication
(10) Pub. No.: US 2025/0392727 A1
(43) Pub. Date: Dec. 25, 2025

(54) METHODS, SYSTEMS, AND APPARATUSES FOR INTRA PREDICTION

(71) Applicant: GUANGDONG OPPO MOBILE TELECOMMUNICATIONS CORP., LTD., Dongguan (CN)

(72) Inventors: Yue YU, Palo Alto, CA (US); Jonathan GAN, Palo Alto, CA (US); Haoping YU, Palo Alto, CA (US)

(21) Appl. No.: 18/879,969

(22) PCT Filed: Jul. 21, 2023
(86) PCT No.: PCT/US2023/028389

§ 371 Date: Dec. 30, 2024

Related U.S. Application Data
(60) Provisional application No. 63/369,057, filed on Jul. 21, 2022.

(51) Int. Cl. H04N 19/159; H04N 19/105; H04N 19/176

(52) U.S. Cl. CPC H04N 19/159; H04N 19/176; H04N 19/105

(57) ABSTRACT

A prediction method applied to a video decoder includes decoding an intra prediction mode from a bitstream and performing an intra fusion prediction of a current block to obtain a prediction block, where the intra fusion prediction includes predicting the current block based on a plurality of reference sample lines and the intra prediction mode.

### CROSS REFERENCE TO RELATED APPLICATIONS

This application is a national phase entry under 35 USC 371 of International Patent Application No. PCT/US2023/028389 filed on Jul. 21, 2023, which claims priority to U.S. Provisional Application No. 63/369,057, entitled “INTRA FUSION FOR VIDEO CODING,” filed on Jul. 21, 2022, which are hereby incorporated in their entireties by this reference.

### TECHNICAL FIELD

The present disclosure relates to the field of augmented reality (AR) and/or video technologies, and more particularly, to methods, systems, and apparatuses for intra prediction, which can provide at least one improvement for intra fusion for video coding (including video encoding and/or video decoding).

### BACKGROUND

A video is a collection of points in a 3-dimensional space. The points may correspond to points on objects within the 3-dimensional space. Thus, a video may be used to represent the physical content of the 3-dimensional space. Videos may have utility in a wide variety of situations. For example, videos may be used in the context of autonomous vehicles for representing the positions of objects on a roadway. In another example, videos may be used in the context of representing the physical content of an environment for purposes of positioning virtual objects in an augmented reality (AR) or mixed reality (MR) application. Video compression is a process for coding (including encoding and/or decoding) videos. Encoding videos may reduce the amount of data required for storage and transmission of videos.

Generally, intra fusion may respectively use a first reference line and a second reference line to generate a first prediction block and a second prediction block, which may place additional burden on a decoder. The second reference line is further away from a current block, which may require an additional line buffer. In addition, two prediction blocks (i.e., the first prediction block and the second prediction block) are generated first with two reference lines (i.e., the first reference line and the second reference line) and a same given intra mode, followed by fusion. Generation of a prediction block from a reference line is a complex operation because it may require interpolation filtering when sample values at non-integer locations in the reference line are required. Requiring two prediction blocks is a significant increase in complexity. Furthermore, there is no intra fusion for chroma block, the overall coding performance needs to be further improved. Therefore, there is a need for methods, systems, and apparatuses for intra prediction, which can provide at least one improvement for intra fusion for video coding (including video encoding and/or video decoding).

### SUMMARY

An object of the present disclosure is to propose methods, systems, and apparatuses for intra prediction.

In a first aspect of the present disclosure, a prediction method applied to a video decoder includes decoding an intra prediction mode from a bitstream and performing an intra fusion prediction of a current block to obtain a prediction block, wherein the intra fusion prediction includes predicting the current block based on a plurality of reference sample lines and the intra prediction mode.

In a second aspect of the present disclosure, a prediction method applied to a video encoder includes performing an intra fusion prediction of a current block to obtain a prediction block, wherein the intra fusion prediction includes predicting the current block based on a plurality of reference sample lines and an intra prediction mode and encoding the intra prediction mode into a bitstream.

In a third aspect of the present disclosure, a prediction method applied to a video coder includes performing an intra fusion prediction of a current block to obtain a prediction block, wherein the intra fusion prediction includes predicting the current block based on a plurality of reference sample lines and an intra prediction mode and coding the intra prediction mode into or from a bitstream.

In a fourth aspect of the present disclosure, a video decoder includes a decoder configured to decode an intra prediction mode from a bitstream and a prediction circuit configured to perform an intra fusion prediction of a current block to obtain a prediction block, wherein the intra fusion prediction includes predicting the current block based on a plurality of reference sample lines and the intra prediction mode.

In a fifth aspect of the present disclosure, a video encoder includes a prediction circuit configured to perform an intra fusion prediction of a current block to obtain a prediction block, wherein the intra fusion prediction includes predicting the current block based on a plurality of reference sample lines and an intra prediction mode and an encoder configured to encode the intra prediction mode into a bitstream.

In a sixth aspect of the present disclosure, a video coder includes a prediction circuit configured to perform an intra fusion prediction of a current block to obtain a prediction block, wherein the intra fusion prediction includes predicting the current block based on a plurality of reference sample lines and an intra prediction mode and a coder configured to code the intra prediction mode into or from a bitstream.

In a seventh aspect of the present disclosure, a video decoding device includes a memory, a transceiver, and a processor coupled to the memory and the transceiver. The processor is configured to perform the above video decoding method.

In an eighth aspect of the present disclosure, a video encoding device includes a memory, a transceiver, and a processor coupled to the memory and the transceiver. The processor is configured to perform the above video encoding method.

In a ninth aspect of the present disclosure, a video coding device includes a memory, a transceiver, and a processor coupled to the memory and the transceiver. The processor is configured to perform the above video coding method.

In a tenth aspect of the present disclosure, a non-transitory machine-readable storage medium has stored thereon instructions that, when executed by a computer, cause the computer to perform the above method.

In an eleventh aspect of the present disclosure, a chip includes a processor, configured to call and run a computer program stored in a memory, to cause a device in which the chip is installed to execute the above method.

In a twelfth aspect of the present disclosure, a computer readable storage medium, in which a computer program is stored, causes a computer to execute the above method.

In a thirteenth aspect of the present disclosure, a computer program product includes a computer program, and the computer program causes a computer to execute the above method.

In a fourteenth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic structural diagram illustrating an example of a geometry point cloud compression (G-PCC)-based system configured to implement some embodiments presented herein.

FIG. 2 is a schematic structural diagram illustrating an example of a G-PCC encoder configured to implement some embodiments presented herein.

FIG. 3 is a schematic structural diagram illustrating an example of a G-PCC decoder configured to implement some embodiments presented herein.

FIG. 4 is a schematic structural diagram of octree structure of G-PCC and corresponding digital representation, according to some embodiments of the present disclosure.

FIG. 5 is a schematic structural diagram of a structure of cube and relationship with neighboring cubes, according to some embodiments of the present disclosure.

FIG. 6 is a block diagram illustrating an example of a video encoder configured to implement some embodiments presented herein.

FIG. 7 is a block diagram illustrating an example of a video decoder configured to implement embodiments presented herein.

FIG. 8 depicts an example of a coding tree unit division of a picture in a video, according to some embodiments of the present disclosure.

FIG. 9 depicts an example of a coding unit division of a coding tree unit (CTU), according to some embodiments of the present disclosure.

FIG. 10 depicts an example of a current block and spatially adjacent and non-adjacent reconstructed samples to the current block, according to some embodiments of the present disclosure.

FIG. 11 depicts an example of angular modes and wide-angle intra prediction (WAIP) modes, according to some embodiments of the present disclosure.

FIG. 12 is a block diagram illustrating an example of a video coder according to an embodiment of the present application.

FIG. 13 is a block diagram of an example of a coding device according to an embodiment of the present disclosure.

FIG. 14 is a flowchart of an example of a prediction method applied to a video coder according to an embodiment of the present disclosure.

FIG. 15 is a block diagram illustrating an example of a video encoder according to an embodiment of the present application.

FIG. 16 is a block diagram of an example of an encoding device according to an embodiment of the present disclosure.

FIG. 17 is a flowchart of an example of a prediction method applied to a video encoder according to an embodiment of the present disclosure.

FIG. 18 is a block diagram illustrating an example of a video decoder according to an embodiment of the present application.

FIG. 19 is a block diagram of an example of a decoding device according to an embodiment of the present disclosure.

FIG. 20 is a flowchart diagram of an example of a prediction method applied to a video decoder according to an embodiment of the present disclosure.

FIG. 21 is a block diagram of an example of a computing device according to an embodiment of the present disclosure.

FIG. 22 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In some embodiments of the present disclosure, coding refers to encoding and/or decoding, and more particularly, to encoding and/or decoding methods, systems, or apparatuses.

Various embodiments can provide quantization for video coding. More and more video data are being generated, stored, and transmitted. It is beneficial to increase a coding performance of video coding technologies thereby using less data to represent a video without compromising a visual quality of the decoded video. One aspect of some embodiments to improve the coding performance is to improve the quantization scheme of the video coding. The latest video coding standards, such as versatile video coding (VVC), have employed quantization techniques. Some embodiments provide improvements in coding performance by provide some intra fusion methods for intra prediction for video coding. The proposed methods of some embodiments may be used for future video coding standard. With the implementation of the proposed methods of some embodiments, modifications to bitstream structure, syntax, constraints, and mapping for the generation of decoded pictures are considered for standardizing. The techniques can be an effective coding tool in future video coding standards.

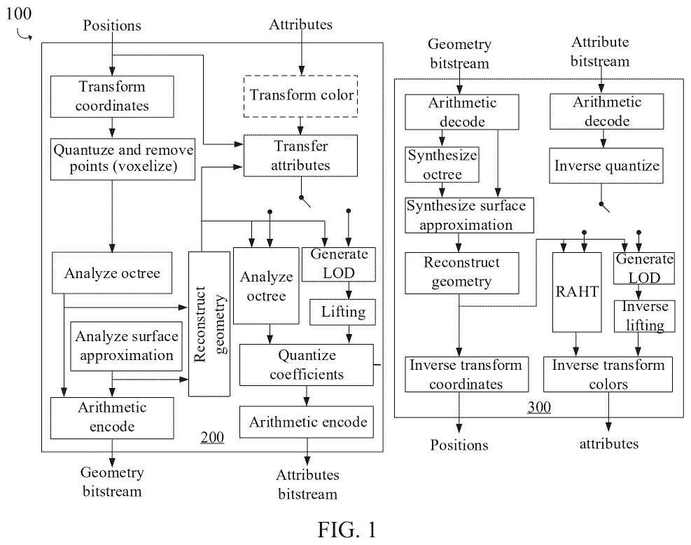

Geometry point cloud compression (G-PCC) is widely used in virtual reality/augmented reality/mixed reality (VR/AR/MR) for entertainment and industrial applications, e.g., light detection and ranging (LiDAR) sweep compression for automotive or robotics and high definition (HD) map for navigation. Moving picture experts group (MPEG) has released the first version G-PCC standard and audio video coding standard (AVS) is also developing a G-PCC standard. In order to compress video data efficiently, a geometry of a video is compressed first, and corresponding attributes including color and/or reflectance, etc., are compressed based upon geometry information. A geometry video coding (G-PCC) system 100 including a G-PCC encoder 200 and/or a G-PCC decoder 300 is illustrated in FIG. 1.

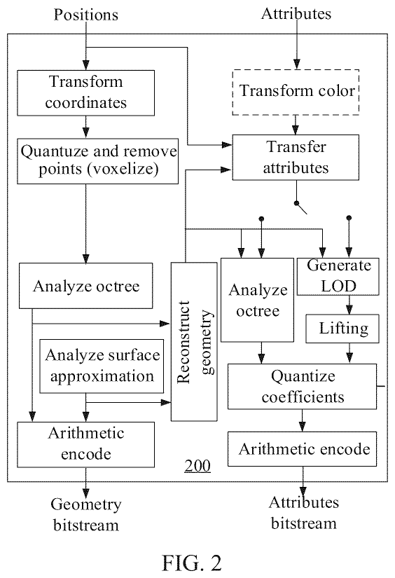

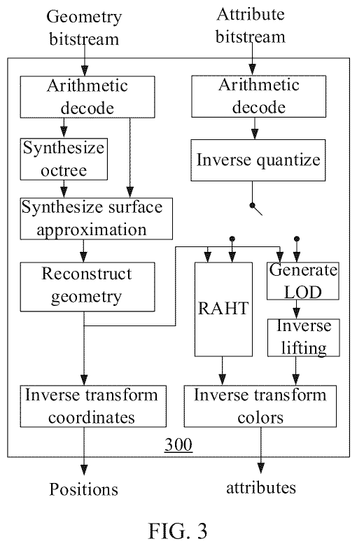

FIG. 1 provides an overview of the G-PCC system 100 including the G-PCC encoder 200 and/or the G-PCC decoder 300 configured to implement some embodiments presented herein. The G-PCC system 100 is configured to implement some embodiments of the disclosure. FIG. 2 provides the G-PCC encoder 200 configured to implement some embodiments presented herein. The G-PCC encoder 200 is configured to implement some embodiments of the disclosure. FIG. 3 provides the G-PCC decoder 300 configured to implement some embodiments presented herein. The G-PCC decoder 300 is configured to implement some embodiments of the disclosure. Modules illustrated in FIG. 1, FIG. 2, and FIG. 3 are logical. Some embodiments of the disclosure may be implemented into the G-PCC system 100, the G-PCC encoder 200, and/or the G-PCC decoder 300 using any suitably configured hardware and/or software. In both the G-PCC encoder 200 and G-PCC decoder 300, video positions are coded first. Attribute coding depends on the decoded geometry. At least one module such as analyze surface approximation and/or RAHT (region adaptive hierarchical transform) of the G-PCC encoder as illustrated in FIG. 1 and FIG. 2 and/or synthesize surface approximation and/or RAHT of the G-PCC decoder as illustrated in FIG. 1 and FIG. 3 is an option used for Category 1 data. At least one module such as generate LOD (level of detail) and/or lifting of the G-PCC encoder as illustrated in FIG. 1 and FIG. 2 and/or generate LOD and/or inverse lifting of the G-PCC decoder as illustrated in FIG. 1 and FIG. 3 is an option used for Category 3 data. All the other modules are common between Categories 1 and 3.

For Category 3 data, the compressed geometry may be represented as an octree from the root all the way down to a leaf level of individual voxels. For Category 1 data, the compressed geometry may be represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

There are 3 attribute coding methods in G-PCC: Region adaptive hierarchical transform (RAHT) coding, interpolation-based hierarchical nearest-neighbor prediction (predicting transform), and interpolation-based hierarchical nearest-neighbor prediction with an update/lifting step (lifting transform). RAHT and lifting are used for Category 1 data, while predicting is used for Category 3 data. However, either method may be used for any data, and just like with the geometry codecs in G-PCC, the user has the option to choose which of the 3 attribute codecs they would like to use.

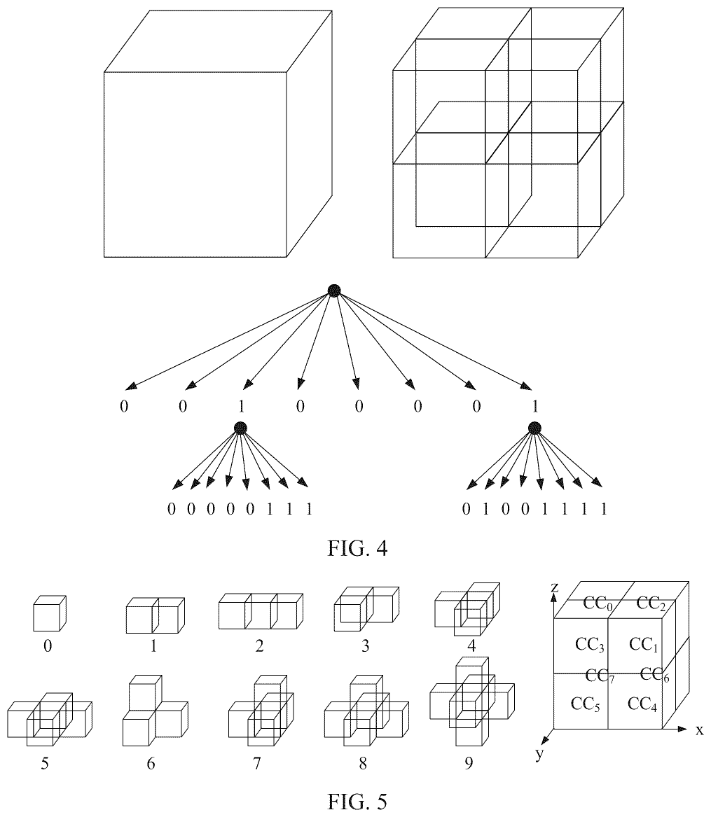

A cubical axis-aligned bounding box is defined by the two extreme points (0,0,0) and (2^{d}, 2^{d}, 2^{d}) where d is the maximum size of the given video along x, y or z direction. A point of video may be noted as point illustrated in FIG. 4. All points are included in this defined cube. A cube is divided into eight sub-cubes, which creates the octree structure allowing one parent cube to have 8 child cubes. The 7 sibling cubes of a given cube are the same size cubes and share at least one same face/edge/point with this given cube. The volume of a cube is ⅛ volume of its parent cube. A cube may contain more than one point and the number of points in a cube is dependent on the size and location of the cube. The size of a smallest cube is pre-defined for a given video. As one example, a minimum cube can be defined. For a given point, the parent cube of a given point is defined as a minimum size cube which contains this given point. Sibling points of a given point are defined as those points which have the same parent cube with this given point.

FIG. 4 demonstrates an octree structure of G-PCC and the corresponding digital representation. An octree is a recursive data structure that may be used to describe three-dimensional space in which each internal cube has exactly eight children. The space is recursively subdivided into eight octants to the point where the resolution of the child cube is equal to a size of the point—the smallest element that has no further subdivisions. To represent a cube an 8-bit binary code that follows a space-filling curve pattern (Hilbert, Morton) is used, each child is assigned a “1” or “0” value to indicate if the space in the child cube has any points associated with that child cube, or the child cube is empty. Only the occupied child cubes are further subdivided. The process of parent cube subdivision is terminated when the size of the child cube becomes equal to the size of the indivisible element, i.e., spatial resolution of the video, or simply the size of the point.

FIG. 5 illustrates a structure of cube and relationship with neighboring cubes. Depending on the location of the current cube, one cube may have up to six same-size cubes to share one face, as illustrated in FIG. 5. In addition, the current cube may also have some neighboring cubes which share lines or point with the current cube. Similarly, the parent cube of the current cube also has up to six neighboring cubes with the same size of the parent cube that share one face with the parent cube. The parent cube of the current cube also has up to twelve neighboring cubes with the same size of parent cubes that share an edge. The parent cube of the current cube also has up to eight neighboring cubes with the same size of parent cubes that share a point with the parent cube.

The octree-based geometry information may be coded with context-based arithmetic coding. There may also be some corresponding attribute information for videos, including color, reflectance, etc., that needs to be compressed. Because the neighboring points in a video may have a strong correlation, prediction-based coding methods have been developed and used to compose and code video attributes. More specifically, a prediction is formed from neighboring coded attributes. Further, the difference between the current attribute and the prediction is coded.

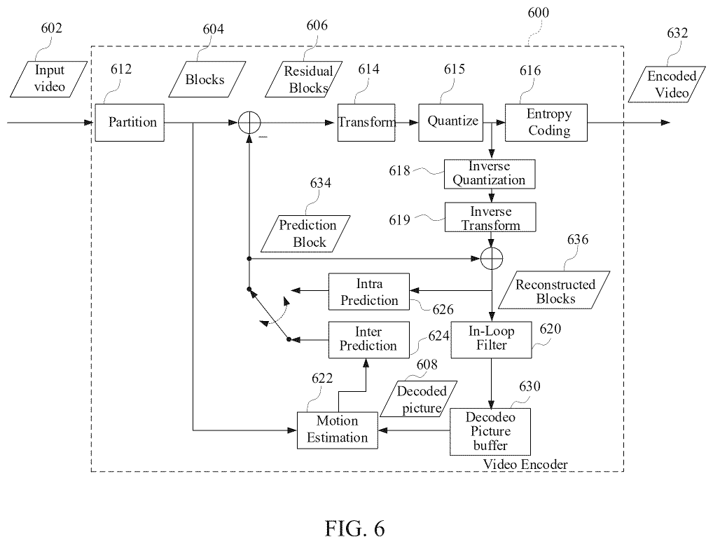

FIG. 6 is a block diagram illustrating an example of a video encoder 600 configured to implement embodiments presented herein. In some examples illustrated in FIG. 6, a video encoder 600 includes a partition module 612, a transform module 614, a quantization module 615, an inverse quantization module 618, an inverse transform module 619, an in-loop filter module 620, an intra prediction module 626, an inter prediction module 624, a motion estimation module 622, a decoded picture buffer 630, and an entropy coding module 616.

The input to the video encoder 600 is an input video 602 containing a sequence of pictures (also referred to as frames or images). In a block-based video encoder, for each of the pictures, the video encoder 600 employs a partition module 612 to partition the picture into blocks 604, and each block containing multiple pixels. The blocks may be macroblocks, coding tree units, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

The first picture of a video signal may be an intra-predicted picture, which may be encoded using only intra prediction. In the intra prediction mode, a block of a picture may be predicted using only data from the same picture. A picture that is intra-predicted can be decoded without information from other pictures. To perform the intra-prediction, the video encoder 600 as illustrated in FIG. 6 can employ the intra prediction module 626. The intra prediction module 626 is configured to use reconstructed samples in reconstructed blocks 636 of neighboring blocks of the same picture to generate an intra-prediction block (the prediction block 634). The intra prediction is performed according to an intra-prediction mode selected for the block. The video encoder 600 then calculates the difference between block 604 and the intra-prediction block 634. This difference is referred to as residual block 606.

To further remove the redundancy from the block, the residual block 606 is transformed by the transform module 614 into a transform domain by applying a transform on the samples in the block. Examples of the transform may include, but are not limited to, a discrete cosine transform (DCT) or a discrete sine transform (DST). The transformed values may be referred to as transform coefficients representing the residual block in the transform domain. In some examples, the residual block may be quantized directly without being transformed by the transform module 614. This is referred to as a transform skip mode.

The video encoder 600 can further use the quantization module 615 to quantize the transform coefficients to obtain quantized coefficients. Quantization includes dividing a sample by a quantization step size followed by subsequent rounding. In some examples, inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The quantization of coefficients/samples within a block can be done independently and this kind of quantization method is used in some current video compression standards, such as H.264, and high efficiency video coding (HEVC). For an N-by-M block, a specific scan order may be used to convert 2D coefficients of a block into a 1-D array for coefficient quantization and coding. Quantization of a coefficient within a block may make use of the scan order information. For example, the quantization of a given coefficient in the block may depend on the status of the previous quantized value along the scan order. To further improve the coding efficiency, more than one quantizer may be used. Which quantizer is used for quantizing a current coefficient depends on the information preceding the current coefficient in encoding/decoding scan order. Such a quantization approach is referred to as dependent quantization.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). The quantization parameters are provided in the encoded bitstream of the video such that the video decoder can apply the same quantization parameters for decoding.

The quantized samples are then coded by the entropy coding module 616 to further reduce the size of the video signal. The entropy encoding module 616 is configured to apply an entropy encoding algorithm on the quantized samples. Examples of the entropy encoding algorithm include, but are not limited to, a variable length coding (VLC) scheme, a context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding, or other entropy encoding techniques. The entropy-coded data is added to the bitstream of the output encoded video 632.

The reconstructed blocks 636 from neighboring blocks are used in the intra-prediction of blocks of a picture. Generating the reconstructed block 636 of a block involves calculating the reconstructed residuals of this block. The reconstructed residual can be determined by applying inverse quantization and inverse transform on the quantized residual of the block. The inverse quantization module 618 is configured to apply the inverse quantization on the quantized samples to obtain de-quantized coefficients. The inverse quantization module 618 applies the inverse of the quantization scheme applied by the quantization module 615 by using the same quantization step size as the quantization module 615. The inverse transform module 619 is configured to apply the inverse transform of the transform applied by the transform module 614 on the de-quantized samples, such as inverse DCT or inverse DST. The output of the inverse transform module 619 is the reconstructed residuals for the block in the pixel domain. The reconstructed residuals can be added to the prediction block 634 of the block to obtain a reconstructed block 636 in the pixel domain. For blocks where the transform is skipped, the inverse transform module 619 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 600 uses an inter prediction module 624. The inter prediction module 624 is configured to perform motion compensation for a block based on the motion estimation provided by the motion estimation module 622.

The motion estimation module 622 compares a current block 604 of the current picture with decoded reference pictures 608 for motion estimation. The decoded reference pictures 608 are stored in a decoded picture buffer 630. The motion estimation module 622 selects a reference block from the decoded reference pictures 608 that best matches the current block. The motion estimation module 622 further identifies an offset between the position (e.g., x, y coordinates) of the reference block and the position of the current block. This offset is referred to as the motion vector (MV) and is provided to the inter prediction module 624. In some cases, multiple reference blocks are identified for the block in multiple decoded reference pictures 608. Therefore, multiple motion vectors are generated and provided to the inter prediction module 624.

The inter prediction module 624 uses the motion vector(s) along with other inter-prediction parameters to perform motion compensation to generate a prediction of the current block, i.e., the inter prediction block 634. For example, based on the motion vector(s), the inter prediction module 624 can locate the prediction block(s) pointed to by the motion vector(s) in the corresponding reference picture(s). If there are more than one prediction blocks, these prediction blocks are combined with some weights to generate a prediction block 634 for the current block.

For inter-predicted blocks, the video encoder 600 can subtract the inter-prediction block 634 from the block 604 to generate the residual block 606. The residual block 606 can be transformed, quantized, and entropy coded in the same way as the residuals of an intra-predicted block discussed above. Likewise, the reconstructed block 636 of an inter-predicted block can be obtained through inverse quantizing, inverse transforming the residual, and subsequently combining with the corresponding prediction block 634.

To obtain the decoded picture 608 used for motion estimation, the reconstructed block 636 is processed by an in-loop filter module 620. The in-loop filter module 620 is configured to smooth out pixel transitions thereby improving the video quality. The in-loop filter module 620 may be configured to implement one or more in-loop filters, such as a de-blocking filter, or a sample-adaptive offset (SAO) filter, or an adaptive loop filter (ALF), etc.

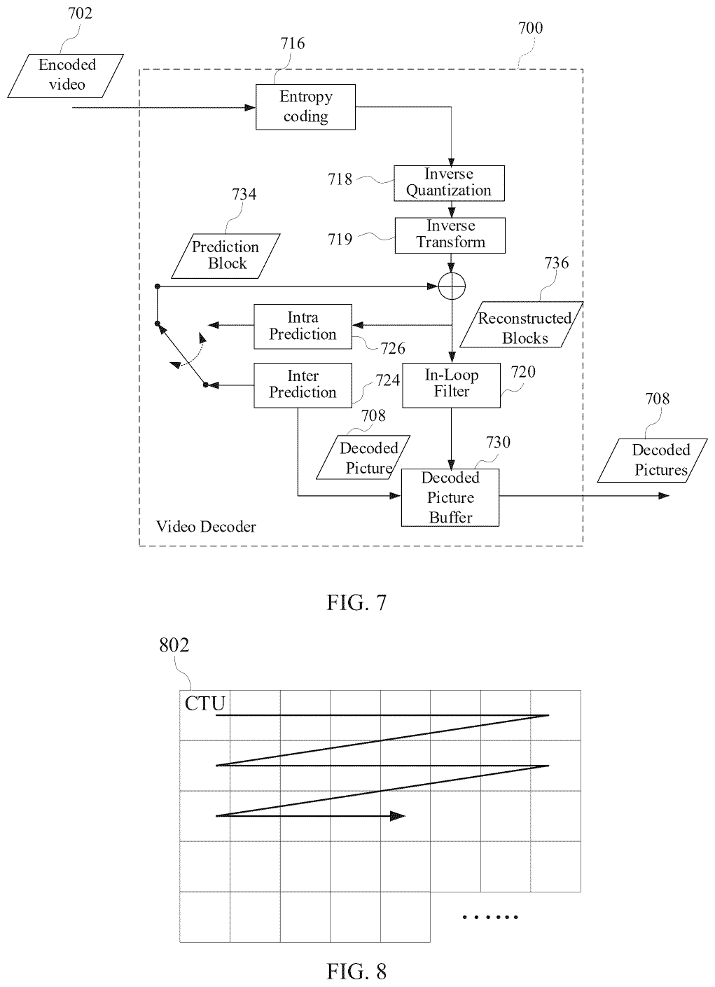

FIG. 7 depicts an example of a video decoder 700 configured to implement embodiments presented herein. The video decoder 700 processes an encoded video 702 in a bitstream and generates decoded pictures 708. In some examples illustrated in FIG. 7, the video decoder 700 includes an entropy decoding module 716, an inverse quantization module 718, an inverse transform module 719, an in-loop filter module 720, an intra prediction module 726, an inter prediction module 724, and a decoded picture buffer 730.

The entropy decoding module 716 is configured to perform entropy decoding of the encoded video 702. The entropy decoding module 716 decodes the quantized coefficients, coding parameters including intra prediction parameters and inter prediction parameters, and other information. The entropy-decoded coefficients are then inverse quantized by the inverse quantization module 718 and subsequently inverse transformed by the inverse transform module 719 to the pixel domain. The inverse quantization module 718 and the inverse transform module 719 function similarly as the inverse quantization module 618 and the inverse transform module 619, respectively, as described above with respect to FIG. 6. The inverse-transformed residual block can be added to the corresponding prediction block 734 to generate a reconstructed block 736. For blocks where the transform is skipped, the inverse transform module 719 is not applied to those blocks. The de-quantized samples generated by the inverse quantization module 618 are used to generate the reconstructed block 736.

The prediction block 734 of a particular block is generated based on the prediction mode of the block. If the coding parameters of the block indicate that the block is intra predicted, the reconstructed block 736 of a reference block in the same picture can be fed into the intra prediction module 726 to generate the prediction block 734 for the block. If the coding parameters of the block indicate that the block is inter-predicted, the prediction block 734 is generated by the inter prediction module 724. The intra prediction module 726 and the inter prediction module 724 function similarly as the intra prediction module 626 and the inter prediction module 624 of FIG. 6, respectively.

The inter prediction involves one or more reference pictures. The video decoder 700 generates the decoded pictures 708 for the reference pictures by applying the in-loop filter module 720 to the reconstructed blocks of the reference pictures. The decoded pictures 708 are stored in the decoded picture buffer 730 for use by the inter prediction module 724 and for output.

Referring to FIG. 8, FIG. 8 depicts an example of a coding tree unit division of a picture in a video, according to some embodiments of the present disclosure. As discussed above with respect to FIGS. 6 and 7, to encode a picture of a video, the picture is divided into blocks, such as (coding tree units) CTUs 802 in VVC, as illustrated in FIG. 8. Like other video coding schemes like HEVC, VVC is a block-based hybrid spatial and temporal predictive coding scheme. During coding, an input picture is first divided into square blocks called CTUs 802, as illustrated in FIG. 8. For example, the CTUs 802 can be blocks of 128×128 pixels.

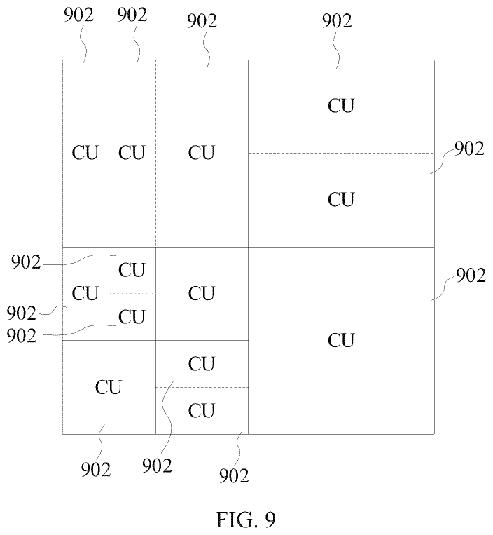

The CTUs are processed according to an order, such as the order illustrated in FIG. 8. In some examples, each CTU 802 in a picture can be partitioned into one or more (coding units) (CUs) 902 as illustrated in FIG. 9, which can be used for prediction and transformation. Depending on the coding schemes, a CTU 802 may be partitioned into CUs 902 differently. For example, Unlike HEVC, in VVC, the CUs 902 can be rectangular or square, and can be coded without further partitioning into prediction units or transform units. Each CU 902 can be as large as its root CTU 802 or be subdivisions of a root CTU 802 as small as 4×4 blocks as illustrated in FIG. 9. As illustrated in FIG. 9, a division of a CTU 802 into CUs 902 in VVC can be quadtree splitting or binary tree splitting or ternary tree splitting. In FIG. 9, solid lines indicate quadtree splitting and dashed lines indicate binary tree splitting.

### Dependent Quantization

As discussed above with respect to FIGS. 6 and 7, quantization is used to reduce the dynamic range of elements of blocks in the video signal so that fewer bits are used to represent the video signal. In some examples, before quantization, an element at a specific position of the block is referred to as a coefficient. After quantization, the quantized value of the coefficient is referred to as a quantization level or a level. Quantization typically consists of division by a quantization step size and subsequent rounding while inverse quantization consists of multiplication by the quantization step size. Such a quantization process is also referred to as scalar quantization. The quantization of the coefficients within a block can be performed independently and this kind of independent quantization method is used in some existing video compression standards, such as H.264, HEVC, etc. In other examples, dependent quantization is employed, such as in VVC.

VVC can be employed with many new coding tools, the details of these tools are described in some embodiments.
1) Angular intra prediction with 65 Angles and 4-tap interpolation filters: Angular intra prediction with 65 different directions is enabled. Two types of 4-tap interpolation and smoothing filters are used in the prediction generation.
2) Wide-angle intra prediction (WAIP): For the newly added non-square/rectangular intra block shapes, angular intra prediction modes with wider angles of prediction are added in addition to those enabled for square blocks.
3) position dependent prediction combination (PDPC): Filtering with spatially varying weights is applied to blocks that use planar and DC modes as well as certain angular modes.
4) Multiple reference line (MRL) prediction: The reconstructed samples used as reference samples in the angular and the DC prediction modes can be obtained from samples that lie two or three lines to the left and above a block.
5) Intra subpartition (ISP) mode: Intra predicted blocks can be subdivided either horizontally or vertically into smaller blocks called subpartitions. On each of them, the prediction and transform coding operations are performed separately, but the intra mode is shared across all subpartitions.
6) Matrix-Based Intra Prediction (MIP): The intra prediction samples can be generated by modes which perform a downsampling of the reference samples, a matrix vector multiplication and an upsampling of the result.
7) Cross component linear model (CCLM): The chroma components of a block can be predicted from the collocated reconstructed luma samples by linear models whose parameters are derived from already reconstructed luma and chroma samples that are adjacent to the block.
8) Intra mode coding with 6 MPMs: The planar mode, which is a most probable mode (MPM), is coded first with a separate flag. Direct current (DC) mode and angular mode are coded using a list of the remaining five MPMs that are derived from intra modes of neighboring blocks.

### Intra Prediction in VVC and Enhanced Compression Model (ECM)

For intra CUs, spatial neighboring reconstructed samples may be used to predict a current block and an intra mode is signaled once for the entire CU. Intra prediction and transform coding are performed at a transform block (TB) level. Each CU consists of a single TB, except in the cases of intra subpartition (ISP) mode and implicit splitting. For luma CUs, the maximum side length of a TB is 64 and the minimum side length is 4. In addition, luma TBs are further specified as W×H rectangular blocks of width W and height H, where W, H∈{4, 8, 16, 32, 64}. For chroma CUs, the maximum TB side length is 32 and chroma TBs are rectangular W×H blocks of width W and height H. Here, W, H∈{2, 4, 8, 16, 32}, but blocks of shapes 2×H and 4×2 are excluded in order to address memory architecture and throughput requirements.

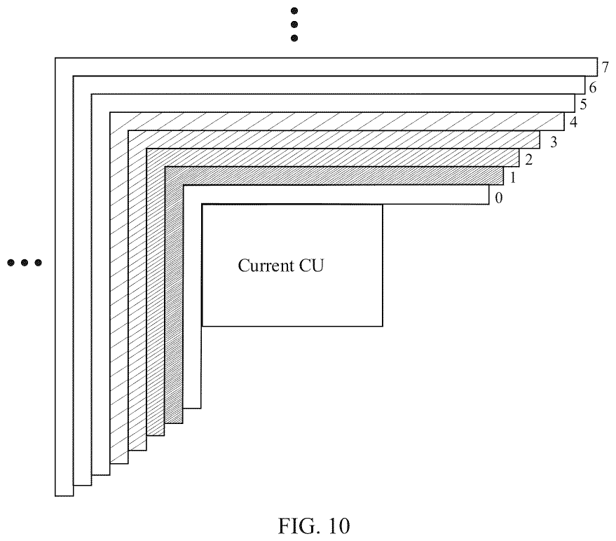

In VVC, the intra prediction samples for the current block are generated using reference samples that are obtained from reconstructed samples of neighboring blocks. For a W×H block, the reference samples are spatially adjacent to the current block, consisting of the vertical line of 2. H reconstructed samples to the left of the block and extending downwards, the top left reconstructed sample, and the horizontal line of 2. W reconstructed samples above the current block and extending to the right. This “L” shaped set of samples may be referred to in this disclosure as a “reference line”. The reference line directly adjacent to the current block is illustrated as the line with index 0 in FIG. 10. FIG. 10 depicts an example of a current block and spatially adjacent and non-adjacent reconstructed samples to the current block, according to some embodiments of the present disclosure. Referring to FIG. 10, the current CU block and spatially adjacent and non-adjacent reconstructed samples to the current block are illustrated, where the number 0, 1, 2, etc. is the index of pixel line.

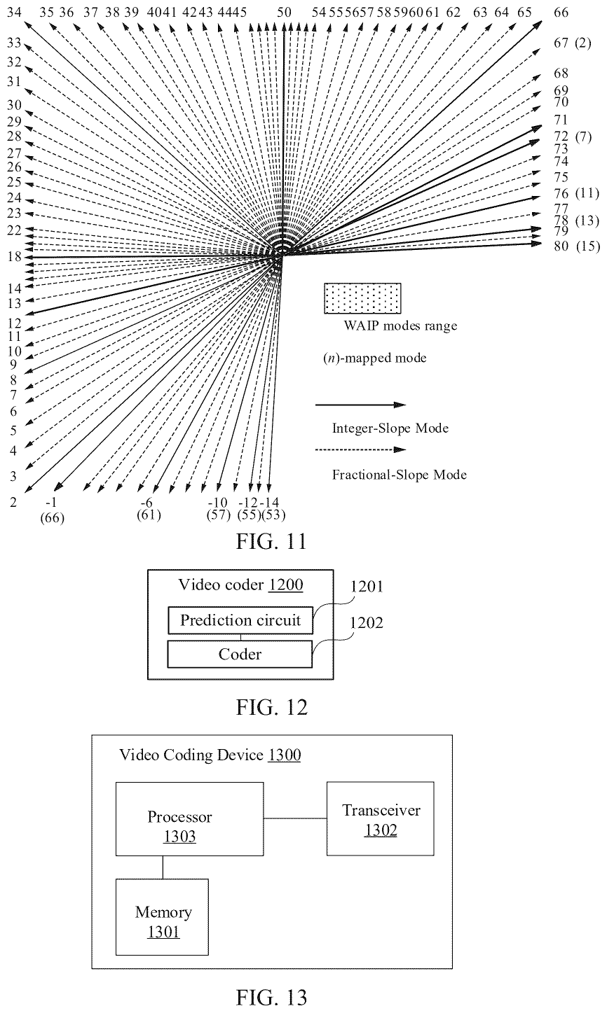

FIG. 11 depicts an example of angular modes and wide-angle intra prediction (WAIP) modes, according to some embodiments of the present disclosure. Like advanced video coding (AVC), and HEVC, VVC also supports angular intra prediction modes. The AVC may refer to video coding in which the video sequence is encoded as a base layer and one or more scalable enhancement layers. Angular intra prediction is a directional intra prediction method. In comparison to HEVC, the angular intra prediction of VVC is modified by increasing the prediction accuracy and by an adaptation to the new partitioning framework. The former is realized by enlarging the number of angular prediction directions and by more accurate interpolation filters, while the latter is achieved by introducing wide-angular intra prediction modes. In VVC, the number of directional modes available for a given block is increased to 65 directions from the 33 HEVC directions. The angular modes of VVC are depicted in FIG. 11. The directions having even indices between 2 and 66 are equivalent to the directions of the angular modes supported in HEVC. For blocks of square shape, an equal number of angular modes is assigned to the top and left side of a block. On the other hand, intra blocks of rectangular shape, which are not present in HEVC, are a central part of VVC's partitioning scheme with additional intra prediction directions assigned to the longer side of a block. The additional modes allocated along a longer side are called WAIP modes, since they correspond to prediction directions with angles greater than 45 degrees relative to the horizontal or vertical mode. A WAIP mode for a given mode index is defined by mapping the original directional mode to a mode that has the opposite direction with an index offset equal to one, as illustrated in FIG. 11. For a given rectangular block, the aspect ratio, i.e., the ratio of width to height, is used to determine which angular modes are to be replaced by the corresponding wide-angular modes.

For square-shaped blocks in VVC, each pair of predicted samples that are horizontally or vertically adjacent are predicted from a pair of adjacent reference samples. To the contrary, WAIP extends the angular range of directional prediction beyond 45 degrees, and therefore, for a coding block predicted with a WAIP mode, adjacent predicted samples may be predicted from non-adjacent reference samples.

In addition to the directly adjacent line of neighboring samples, one of the two non-adjacent reference lines (line 1 and line 2) that are depicted in FIG. 10 can include the input for intra prediction in VVC. For enhanced compression model (ECM), more non-adjacent reference lines may be used. The use of adjacent and non-adjacent reference samples is referred to as multiple reference line (MRL) prediction.

The intra modes that can be used for MRL are a direct current (DC) mode and angular prediction modes. However, for a given block not all these modes can be combined with MRL. The MRL mode is coupled with a most probable mode (MPM) in VVC. This coupling means that if non-adjacent reference lines are used, the intra prediction mode is one of the MPMs. Such a design of an MPM-based MRL prediction mode is motivated by the observation that non-adjacent reference lines are mainly beneficial for texture patterns with sharp and strongly directed edges. In these cases, MPMs are much more frequently selected since there is typically a strong correlation between the texture patterns of the neighboring and the current blocks. On the other hand, choosing a non-MPM for intra prediction is an indication that edges are not consistently distributed in neighboring blocks, and thus the MRL prediction mode is expected to be less useful in this case. In addition, it has been observed that MRL does not provide additional coding gain when the intra prediction mode is the planar mode, since this mode is used for smooth areas.

Consequently, MRL excludes the planar mode, which is one of the MPMs. The angular or DC prediction process in MRL is very similar to the case of a directly adjacent reference line. However, for angular modes with a non-integer slope, a DCT based interpolation filter is always used. This design choice is both evidenced by experimental results and aligned with the empirical observation that MRL is mostly beneficial for sharp and strongly directed edges where s discrete cosine transform (DCT) interpolation filter (DCTIF) is more appropriate since it retains more high frequencies than a smoothing interpolation filter (SIF).

From a hardware design perspective, applying multiple reference lines as proposed in initial methods requires extra cost of line buffers that are used for holding the additional reference lines. In current hardware designs, line buffers are part of the on-chip memory architecture for image and video coding, and it is of great importance to minimize their on-chip area. To address this issue, MRL is disabled and not signaled for the coding units that are attached to the top boundary of the CTU. In this way, the extra buffers for holding non-adjacent reference lines are bounded by 128, which is the width of the largest unit size.

An intra prediction fusion method is proposed to improve the accuracy of intra prediction. More specifically, if the current block is a luma block, and it is coded with a non-integer slope angular mode and not as ISP mode, and the block size (width*height) is greater than 16, two prediction blocks generated from two different reference lines will be “fused”, where fusion is weighted summation of the two prediction blocks. More specifically, a first reference line at index i (lineᵢ) is specified with the current method of signaling in the bitstream, and the prediction block generated from this reference line using the selected intra prediction mode is denoted as p(lineᵢ), where p(⋅) represents the operation of generating a prediction block from a reference line with a given intra prediction mode. The reference line lineᵢ₊₁ is implicitly selected as the second reference line. That is, the second reference line is one index position further away from the current block relative to the first reference line. Similarly, the prediction block generated from the second reference line is denoted as p(lineᵢ₊₁). The weighted sum of the two prediction blocks is obtained as follows and serves as the predictor for the current block.

p_{fusion}=w₀*p(lineᵢ)+w₁*p(lineᵢ₊₁), where p_{fusion} represents the fused prediction, w₀ and w₁ are two weighting factors and they are set as ¾ and ¼ in the experiment, respectively.

Some embodiments of the disclosure propose methods, systems, and apparatuses for video coding, which can provide at least one improvement for intra fusion to provide improved coding performance for video coding. The at least one proposed solution, method, system, and apparatus of some embodiments of the present disclosure may be used for current and/or new/future video coding standards. Compatible products follow at least one proposed solution, method, system, and apparatus of some embodiments of the present disclosure. The proposed solution, method, system, and apparatus are widely used in the video coding products and/or video compression-related products. With the implementation of the at least one proposed solution, method, system, and apparatus of some embodiments of the present disclosure, at least one modification to bitstream structure, syntax, constraints, and mapping for the generation of decoded video are considered for standardizing.

### Technical Solution

In some embodiments of this disclosure, some technical solutions/improvements are proposed to improve intra fusion. The intra fusion in the following solutions may be as follows: For intra CUs, spatial neighboring reconstructed samples may be used to predict a current block and an intra mode is signaled once for the entire CU. Intra prediction and transform coding may be performed at a transform block (TB) level.

Form a decoding side: A prediction method applied to a video decoder includes decoding an intra prediction mode from a bitstream; and performing an intra fusion prediction of a current block to obtain a prediction block, wherein the intra fusion prediction includes predicting the current block based on a plurality of reference sample lines and the intra prediction mode.

Form an encoding side: A prediction method applied to a video encoder includes performing an intra fusion prediction of a current block to obtain a prediction block, wherein the intra fusion prediction includes predicting the current block based on a plurality of reference sample lines and an intra prediction mode; and encoding the intra prediction mode into a bitstream.

Form a coding side (including encoding and/or decoding): A prediction method applied to a video coder includes performing an intra fusion prediction of a current block to obtain a prediction block, wherein the intra fusion prediction includes predicting the current block based on a plurality of reference sample lines and an intra prediction mode and coding the intra prediction mode into or from a bitstream.

### Solution 1

In some examples, intra fusion may be used for integer slope angular mode (or called integer-slope mode). That is, the intra prediction mode includes an integer-slope mode. In some examples, enabling the intra fusion prediction in case the intra prediction mode indicates an integer-slope prediction direction. In addition, in some examples, intra fusion with integer slope may be constrained with some block size restrictions, e.g., it is only allowed for block size (width*height) smaller than N or larger than N. In some examples, N may be equal to 16. In some examples, enabling the intra fusion prediction in case a width of the current block, a height of the current block, an/or a block size of the current block within a range value based on the plurality of reference sample lines and the intra prediction mode.

### Solution 2

In some examples, when a first reference line lineᵢ specified in a bitstream representing a video through a signaling is not a line at index 0, a reference line lineᵢ₋₁ may be selected as a second reference line instead of lineᵢ₊₁. The advantage of this solution is that the second reference line is not further away from the block of the video, which in the current art may require additional buffering. The second reference line may be spatially adjacent to the current block. In some examples, the second reference line is more spatially adjacent to the block than the first reference line.

Then the fused prediction may be obtained as follows.

$${P}_{fusion} = {w}_{0} * p ( {line}_{i} ) + {w}_{1} p ( {line}_{i - 1} )$$

p_{fusion} represents the fused prediction, w₀ and w₁ are weighting factors, p(lineᵢ) represents an operation of generating a first prediction block from the reference line lineᵢ with the intra fusion, and p(lineᵢ₋₁) represents an operation of generating a second prediction block from the reference line lineᵢ₋₁ with the intra fusion. w₀ is set as ¾, and w₁ is set as ¼. Fusion may be weighted summation of the plurality of prediction blocks.

In some examples, p_{fusion} uses at least one sample from a first block such as p(lineᵢ) and at least one sample from a second block such as p(lineᵢ₋₁) to generate the block. The first block p(lineᵢ) uses at least one sample from a first reference line lineᵢ, the second block p(lineᵢ₋₁) uses at least one sample from a second reference line lineᵢ₋₁. In some examples, if the i is equal to 2, the reference index of the first reference line is equal to 2, and the reference index of the second reference line is equal to 1.

In some examples, if the reference index of the first reference line is equal to 0, the reference index of the second reference line is equal to 1.

In some examples, predicting the current block based on the plurality of reference sample lines and the intra prediction mode further includes determining a plurality of prediction blocks by performing prediction based on a plurality of reference sample lines, respectively, such that each prediction block is determined based on each reference sample line, wherein the plurality of reference sample lines are spatially adjacent to each other; and fusing the plurality of prediction blocks into the current block. Fusing may be weighted summation of the plurality of prediction blocks.

### Solution 3:

Instead of using a fusion of two prediction blocks generated from two given reference lines with a given intra prediction mode, in this solution, a fusion of the reference lines is performed first and then the fused reference line is used to generate a prediction block with the given intra prediction mode. line_{fusion} represents the fused reference line. Generation of a prediction block from a reference line is an expensive operation as it may involve interpolation filtering. The advantage of this solution is that regardless of how many reference lines are fused, the prediction block generation is only performed once from the fused reference line.

As one example, line_{fusion}=w_{0*}lineᵢ+w₁*lineᵢ₊₁. As is another example, line_{fusion}=w₀*lineᵢ+w₁*lineᵢ₋₁. As another example, line_{fusion}=w₀*lineᵢ+w₁*lineᵢ₊₁+w₂*lineᵢ₋₁.

line_{fusion} represents the fused reference line, and w₀, w₁, and w₂ are weighting factors.

Some examples use at least one sample from a fused reference line line_{fusion} to generate the block, and the fused reference line line_{fusion} uses samples from a plurality of reference lines. In some examples, the fused reference line line_{fusion} is spatially adjacent to the block, and all of the plurality of reference lines (lineᵢ and lineᵢ₋₁) are spatially adjacent to the block. In some examples, the fused reference line line_{fusion} is spatially adjacent to the block, and one of the plurality of reference lines (lineᵢ₋₁) is spatially away from the block.

In some examples, predicting the current block based on the plurality of reference sample lines and the intra prediction mode further includes fusing the plurality of reference sample lines into a fused reference sample line; and predicting the current block based on the fused reference sample line. Fusing may be weighted summation of the plurality of reference sample lines.

### Solution 4

When chroma is not coded as CCCM or CCLM modes, it may be coded with one of DC, planar or angular modes illustrated in FIG. 11. This solution proposes that an intra prediction fusion method is also used for chroma block. More specifically, if the current chroma block is coded with a non-integer slope angular mode and the block size (width*height) is greater than N, e.g., Nis 16, the intra fusion method could be used to predict the current chroma block. In addition, the above solutions 1, 2, and 3 could also be used separately or jointly to code the current chroma block. In addition, enabling of intra fusion method for coding intra luma/chroma could be signaled jointly or separately at different levels, e.g., sequence parameter set (SPS), picture header (PH), picture parameter set (PPS) and slice header (SH) levels.

FIG. 12 illustrates an example of a video coder 1200 according to an embodiment of the present application. The video coder 1200 is configured to implement some embodiments of the disclosure. Some embodiments of the disclosure may be implemented into the video coder 1200 using any suitably configured hardware and/or software. The video coder 1200 includes a prediction circuit 1201 configured to perform an intra fusion prediction of a current block to obtain a prediction block, wherein the intra fusion prediction includes predicting a current block based on a plurality of reference sample lines and an intra prediction mode and a coder 1202 configured to code the intra prediction mode into or from a bitstream. This can provide at least one improvement for intra fusion for video coding, improve burden on a decoder (such as a video decoding device or a video decoder), and/or improve a coding performance.

FIG. 13 illustrates an example of a video coding device 1300 according to an embodiment of the present disclosure. The video coding device 1300 is configured to implement some embodiments of the disclosure. Some embodiments of the disclosure may be implemented into the coding device 1300 using any suitably configured hardware and/or software. The video coding device 1300 may include a memory 1301, a transceiver 1302, and a processor 1303 coupled to the memory 1301 and the transceiver 1302. The processor 1303 may be configured to implement proposed functions, procedures and/or methods described in this description. Layers of radio interface protocol may be implemented in the processor 1303. The memory 1301 is operatively coupled with the processor 1303 and stores a variety of information to operate the processor 1303. The transceiver 1302 is operatively coupled with the processor 1303, and the transceiver 1302 transmits and/or receives a radio signal. The processor 1303 may include application-specific integrated circuit (ASIC), other chipset, logic circuit and/or data processing device. The memory 1301 may include read-only memory (ROM), random access memory (RAM), flash memory, memory card, storage medium and/or other storage device. The transceiver 1302 may include baseband circuitry to process radio frequency signals. When the embodiments are implemented in software, the techniques described herein can be implemented with modules (e.g., procedures, functions, and so on) that perform the functions described herein. The modules can be stored in the memory 1301 and executed by the processor 1303. The memory 1301 can be implemented within the processor 1303 or external to the processor 1303 in which case those can be communicatively coupled to the processor 1303 via various means as is known in the art.

In some embodiments, the processor 1303 configured to perform an intra fusion prediction of a current block to obtain a prediction block, wherein the intra fusion prediction includes predicting the current block based on a plurality of reference sample lines and an intra prediction mode and code the intra prediction mode into or from a bitstream. This can provide at least one improvement for intra fusion for video coding, improve burden on a decoder (such as a video decoding device or a video decoder), and/or improve a coding performance.

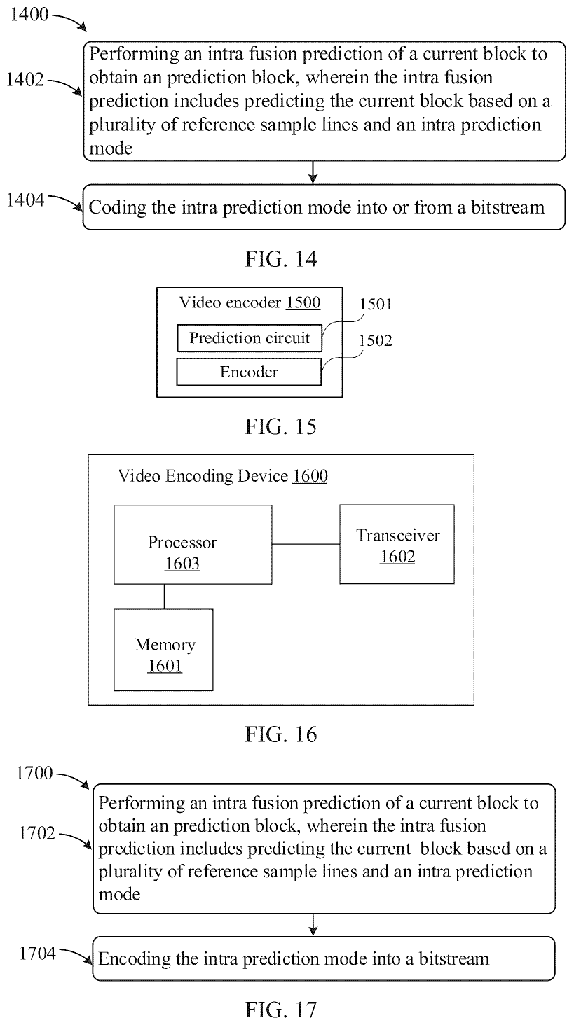

FIG. 14 is an example of a prediction method 1400 applied to a video coder according to an embodiment of the present disclosure. The prediction method 1400 applied to the video coder is configured to implement some embodiments of the disclosure. Some embodiments of the disclosure may be implemented into the prediction method 1400 applied to the video coder using any suitably configured hardware and/or software. In some embodiments, the prediction method 1400 applied to the video coder includes: an operation 1402, performing an intra fusion prediction of a current block to obtain a prediction block, wherein the intra fusion prediction includes predicting the current block based on a plurality of reference sample lines and an intra prediction mode, and an operation 1404, coding the intra prediction mode into or from a bitstream. This can provide at least one improvement for intra fusion for video coding, improve burden on a decoder (such as a video decoding device or a video decoder), and/or improve a coding performance.

In some embodiments, the intra prediction mode includes an integer-slope mode. In some embodiments, enabling the intra fusion prediction in case the intra prediction mode indicates an integer-slope prediction direction. In some embodiments, enabling the intra fusion prediction in case a width of the current block, a height of the current block, an/or a block size of the current block within a range value based on the plurality of reference sample lines and the intra prediction mode.

In some embodiments, predicting the current block based on the plurality of reference sample lines and the intra prediction mode further includes: determining a plurality of prediction blocks by performing prediction based on a plurality of reference sample lines, respectively, such that each prediction block is determined based on each reference sample line, wherein the plurality of reference sample lines are spatially adjacent to each other; and fusing the plurality of prediction blocks into the current block. In some examples, fusing may be weighted summation of the plurality of prediction blocks. In some embodiments, the method further includes coding information into or from the bitstream, wherein the information indicates an index of one of the plurality of reference sample lines. In some embodiments, the one of the plurality of reference sample lines is more spatially adjacent to the current block than another of the plurality of reference sample lines. In some embodiments, the one of the plurality of reference sample lines is spatially adjacent to the current block, and the another of the plurality of reference sample lines is spatially neighboring to the current block. In some embodiments, another of the plurality of reference sample lines is more spatially adjacent to the current block than the one of the plurality of reference sample lines. In some embodiments, the another of the plurality of reference sample lines is spatially adjacent to the current block, and the one of the plurality of reference sample lines is spatially neighboring to the current block. In some embodiments, the plurality of reference sample lines are spatially neighboring to the current block.

In some examples, the plurality of reference sample lines comprises a first reference sample line and a second reference sample line, the method further comprises coding information from or into the bitstream, wherein the information indicates an index of the first reference sample line. In some examples, if the index is equal to 0, the second reference sample line is a reference sample spatially adjacent to the first reference sample line away from the current block. In some examples, if the index is greater than 0, the second reference sample line is a reference sample spatially adjacent to the first reference sample line near the current block.

In some embodiments, predicting the current block based on the plurality of reference sample lines and the intra prediction mode further includes: fusing the plurality of reference sample lines into a fused reference sample line; and predicting the current block based on the fused reference sample line. In some examples, fusing may be weighted summation of the plurality of reference sample lines.

In some embodiments, the method further includes enabling intra fusion prediction for coding luma component and/or chroma component of the current block based on the information and coding information into or from the bitstream. In some embodiments, enabling intra fusion prediction for coding luma component and/or chroma component of the current block is at at least one level. In some embodiments, setting information to indicate enabling of the intra fusion when intra fusion is used. In some embodiments, the information is encoded at at least one level. In some embodiments, the at least one level includes a sequence parameter set (SPS) level, a picture header (PH) level, a picture parameter set (PPS) level, and/or a slice header (SH) level. In some embodiments, the current block includes a chroma block and/or at least one luma block.

FIG. 15 illustrates an example of a video encoder 1500 according to an embodiment of the present application. The video encoder 1500 is configured to implement some embodiments of the disclosure. Some embodiments of the disclosure may be implemented into the video encoder 1500 using any suitably configured hardware and/or software. The video encoder 1500 includes a predict circuit 1501 configured to perform an intra fusion prediction of a current block to obtain a prediction block, wherein the intra fusion prediction includes predicting the current block based on a plurality of reference sample lines and an intra prediction mode and an encoder 1502 configured to encode the intra prediction mode into a bitstream. This can provide at least one improvement for intra fusion for video encoding, improve burden on a decoder (such as a video decoding device or a video decoder), and/or improve a encoding performance.

FIG. 16 illustrates an example of an encoding device 1600 according to an embodiment of the present disclosure. The encoding device 1600 is configured to implement some embodiments of the disclosure. Some embodiments of the disclosure may be implemented into the encoding device 1600 using any suitably configured hardware and/or software. The encoding device 1600 may include a memory 1601, a transceiver 1602, and a processor 1603 coupled to the memory 1601 and the transceiver 1602. The processor 1603 may be configured to implement proposed functions, procedures and/or methods described in this description. Layers of radio interface protocol may be implemented in the processor 1603. The memory 1601 is operatively coupled with the processor 1603 and stores a variety of information to operate the processor 1603. The transceiver 1602 is operatively coupled with the processor 1603, and the transceiver 1602 transmits and/or receives a radio signal. The processor 1603 may include application-specific integrated circuit (ASIC), other chipset, logic circuit and/or data processing device. The memory 1601 may include read-only memory (ROM), random access memory (RAM), flash memory, memory card, storage medium and/or other storage device. The transceiver 1602 may include baseband circuitry to process radio frequency signals. When the embodiments are implemented in software, the techniques described herein can be implemented with modules (e.g., procedures, functions, and so on) that perform the functions described herein. The modules can be stored in the memory 1601 and executed by the processor 1603. The memory 1601 can be implemented within the processor 1603 or external to the processor 1603 in which case those can be communicatively coupled to the processor 1603 via various means as is known in the art.

In some embodiments, the processor 1603 configured to perform an intra fusion prediction of a current block to obtain a prediction block, wherein the intra fusion prediction includes predicting the current block based on a plurality of reference sample lines and an intra prediction mode and encode the intra prediction mode into a bitstream. This can provide at least one improvement for intra fusion for video encoding, improve burden on a decoder (such as a video decoding device or a video decoder), and/or improve a encoding performance.

FIG. 17 is an example of a prediction method 1700 applied to a video encoder according to an embodiment of the present disclosure. The prediction method 1700 applied to the video encoder is configured to implement some embodiments of the disclosure. Some embodiments of the disclosure may be implemented into the prediction method 1700 applied to the video encoder using any suitably configured hardware and/or software. In some embodiments, the prediction method 1700 applied to the video encoder includes: an operation 1702, performing an intra fusion prediction of a current block to obtain a prediction block, wherein the intra fusion prediction includes predicting the current block based on a plurality of reference sample lines and an intra prediction mode, and an operation 1704, encoding the intra prediction mode into a bitstream. This can provide at least one improvement for intra fusion for video encoding, improve burden on a decoder (such as a video decoding device or a video decoder), and/or improve a encoding performance.

In some embodiments, the intra prediction mode includes an integer-slope mode. In some embodiments, enabling the intra fusion prediction in case the intra prediction mode indicates an integer-slope prediction direction. In some embodiments, enabling the intra fusion prediction in case a width of the current block, a height of the current block, an/or a block size of the current block within a range value based on the plurality of reference sample lines and the intra prediction mode.

In some embodiments, predicting the current block based on the plurality of reference sample lines and the intra prediction mode further includes: determining a plurality of prediction blocks by performing prediction based on a plurality of reference sample lines, respectively, such that each prediction block is determined based on each reference sample line, wherein the plurality of reference sample lines are spatially adjacent to each other; and fusing the plurality of prediction blocks into the current block. In some examples, fusing may be weighted summation of the plurality of prediction blocks. In some embodiments, the method further includes encoding information into the bitstream, wherein the information indicates an index of one of the plurality of reference sample lines. In some embodiments, the one of the plurality of reference sample lines is more spatially adjacent to the current block than another of the plurality of reference sample lines. In some embodiments, the one of the plurality of reference sample lines is spatially adjacent to the current block, and the another of the plurality of reference sample lines is spatially neighboring to the current block. In some embodiments, another of the plurality of reference sample lines is more spatially adjacent to the current block than the one of the plurality of reference sample lines. In some embodiments, the another of the plurality of reference sample lines is spatially adjacent to the current block, and the one of the plurality of reference sample lines is spatially neighboring to the current block. In some embodiments, the plurality of reference sample lines are spatially neighboring to the current block.

In some examples, the plurality of reference sample lines comprises a first reference sample line and a second reference sample line, the method further includes encoding information indicating an index of the first reference sample line in to the bitstream. In some examples, if the index is equal to 0, the second reference sample line is a reference sample spatially adjacent to the first reference sample line away from the current block. In some examples, if the index is greater than 0, the second reference sample line is a reference sample spatially adjacent to the first reference sample line near the current block.

In some embodiments, predicting the current block based on the plurality of reference sample lines and the intra prediction mode further includes: fusing the plurality of reference sample lines into a fused reference sample line and predicting the current block based on the fused reference sample line. In some examples, fusing may be weighted summation of the plurality of reference sample lines.

In some embodiments, the method further includes setting information to indicate enabling of the intra fusion when intra fusion is used and encoding information into the bitstream. In some embodiments, the information is encoded at at least one level. In some embodiments, the at least one level includes a sequence parameter set (SPS) level, a picture header (PH) level, a picture parameter set (PPS) level, and/or a slice header (SH) level. In some embodiments, the current block includes a chroma block and/or at least one luma block.

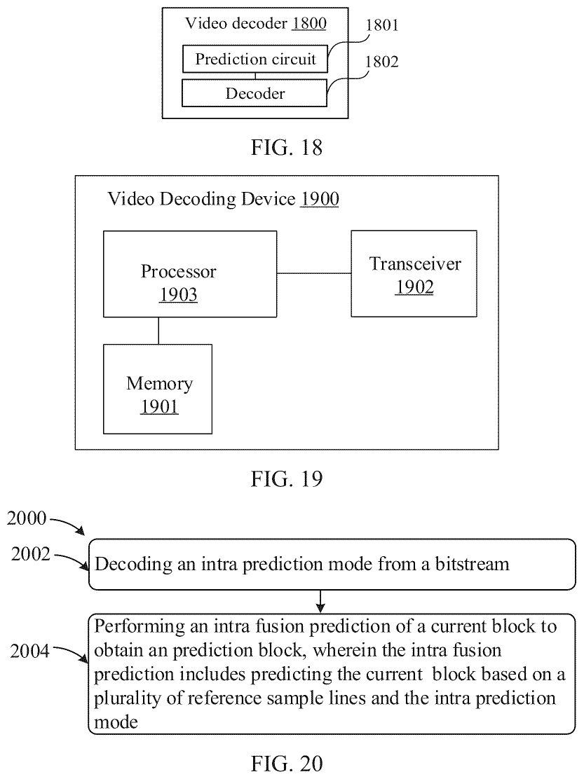

FIG. 18 illustrates an example of a video decoder 1800 according to an embodiment of the present application. The video decoder 1800 is configured to implement some embodiments of the disclosure. Some embodiments of the disclosure may be implemented into the video decoder 1800 using any suitably configured hardware and/or software. The video decoder 1800 includes a decoder 1802 configured to decode an intra prediction mode from a bitstream and a prediction circuit 1801 configured to performing an intra fusion prediction of a current block to obtain a prediction block, wherein the intra fusion prediction includes predicting the current block based on a plurality of reference sample lines and the intra prediction mode. This can provide at least one improvement for intra fusion for video decoding, improve burden on a decoder (such as a video decoding device or a video decoder), and/or improve a decoding performance.

FIG. 19 illustrates an example of a video decoding device 1900 according to an embodiment of the present disclosure. The video decoding device 1900 is configured to implement some embodiments of the disclosure. Some embodiments of the disclosure may be implemented into the video decoding device 1900 using any suitably configured hardware and/or software. The video decoding device 1900 may include a memory 1901, a transceiver 1902, and a processor 1903 coupled to the memory 1901 and the transceiver 1902. The processor 1903 may be configured to implement proposed functions, procedures and/or methods described in this description. Layers of radio interface protocol may be implemented in the processor 1903. The memory 1901 is operatively coupled with the processor 1903 and stores a variety of information to operate the processor 1903. The transceiver 1902 is operatively coupled with the processor 1903, and the transceiver 1902 transmits and/or receives a radio signal. The processor 1903 may include application-specific integrated circuit (ASIC), other chipset, logic circuit and/or data processing device. The memory 1901 may include read-only memory (ROM), random access memory (RAM), flash memory, memory card, storage medium and/or other storage device. The transceiver 1902 may include baseband circuitry to process radio frequency signals. When the embodiments are implemented in software, the techniques described herein can be implemented with modules (e.g., procedures, functions, and so on) that perform the functions described herein. The modules can be stored in the memory 1901 and executed by the processor 1903. The memory 1901 can be implemented within the processor 1903 or external to the processor 1903 in which case those can be communicatively coupled to the processor 1903 via various means as is known in the art.

In some embodiments, the processor 1903 configured to decode an intra prediction mode from a bitstream and perform an intra fusion prediction of a current block to obtain a prediction block, wherein the intra fusion prediction includes predicting the current block based on a plurality of reference sample lines and the intra prediction mode. This can provide at least one improvement for intra fusion for video decoding, improve burden on a decoder (such as a video decoding device or a video decoder), and/or improve a decoding performance.

FIG. 20 is an example of a prediction method 2000 applied to a video decoder according to an embodiment of the present disclosure. The prediction method 2000 applied to the video decoder is configured to implement some embodiments of the disclosure. Some embodiments of the disclosure may be implemented into the prediction method 2000 applied to the video decoder using any suitably configured hardware and/or software. In some embodiments, the prediction method 2000 applied to the video decoder includes: an operation 2002, decoding an intra prediction mode from a bitstream, and an operation 2004, performing an intra fusion prediction of a current block to obtain a prediction block, wherein the intra fusion prediction includes predicting the current block based on a plurality of reference sample lines and the intra prediction mode. This can provide at least one improvement for intra fusion for video decoding, improve burden on a decoder (such as a video decoding device or a video decoder), and/or improve a decoding performance.

In some embodiments, the intra prediction mode includes an integer-slope mode. In some embodiments, enabling the intra fusion prediction in case the intra prediction mode indicates an integer-slope prediction direction. In some embodiments, enabling the intra fusion prediction in case a width of the current block, a height of the current block, an/or a block size of the current block within a range value based on the plurality of reference sample lines and the intra prediction mode.

In some embodiments, predicting the current block based on the plurality of reference sample lines and the intra prediction mode further includes: determining a plurality of prediction blocks by performing prediction based on a plurality of reference sample lines, respectively, such that each prediction block is determined based on each reference sample line, wherein the plurality of reference sample lines are spatially adjacent to each other; and fusing the plurality of prediction blocks into the current block. In some examples, fusing may be weighted summation of the plurality of prediction blocks. In some embodiments, the method further includes decoding information from the bitstream, wherein the information indicates an index of one of the plurality of reference sample lines. In some embodiments, the one of the plurality of reference sample lines is more spatially adjacent to the current block than another of the plurality of reference sample lines. In some embodiments, the one of the plurality of reference sample lines is spatially adjacent to the current block, and the another of the plurality of reference sample lines is spatially neighboring to the current block. In some embodiments, another of the plurality of reference sample lines is more spatially adjacent to the current block than the one of the plurality of reference sample lines. In some embodiments, the another of the plurality of reference sample lines is spatially adjacent to the current block, and the one of the plurality of reference sample lines is spatially neighboring to the current block. In some embodiments, the plurality of reference sample lines are spatially neighboring to the current block.

In some examples, the plurality of reference sample lines comprises a first reference sample line and a second reference sample line, the method further comprises decoding information from the bitstream, wherein the information indicates an index of the first reference sample line. In some examples, if the index is equal to 0, the second reference sample line is a reference sample spatially adjacent to the first reference sample line away from the current block. In some examples, if the index is greater than 0, the second reference sample line is a reference sample spatially adjacent to the first reference sample line near the current block.

In some embodiments, predicting the current block based on the plurality of reference sample lines and the intra prediction mode further includes: fusing the plurality of reference sample lines into a fused reference sample line; and predicting the current block based on the fused reference sample line. In some examples, fusing may be weighted summation of the plurality of reference sample lines.

In some embodiments, the method further includes decoding information from the bitstream and enabling intra fusion prediction for decoding luma component and/or chroma component of the current block based on the information. In some embodiments, enabling intra fusion prediction for decoding luma component and/or chroma component of the current block is at at least one level. In some embodiments, the at least one level includes a sequence parameter set (SPS) level, a picture header (PH) level, a picture parameter set (PPS) level, and/or a slice header (SH) level. In some embodiments, the current block includes a chroma block and/or at least one luma block.

Commercial interests for some embodiments are as follows. 1. Providing at least one improvement for intra fusion for video coding. 2. Improving burden on a decoder (such as a video decoding device or a video decoder). 3. Improving a coding performance. 4. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future coding standards. Compatible products follow at least one proposed solution, method, system, and apparatus of some embodiments of the present disclosure. The proposed solution, method, system, and apparatus of some embodiments of the present disclosure are widely used in the video coding products and/or video compression-related products.

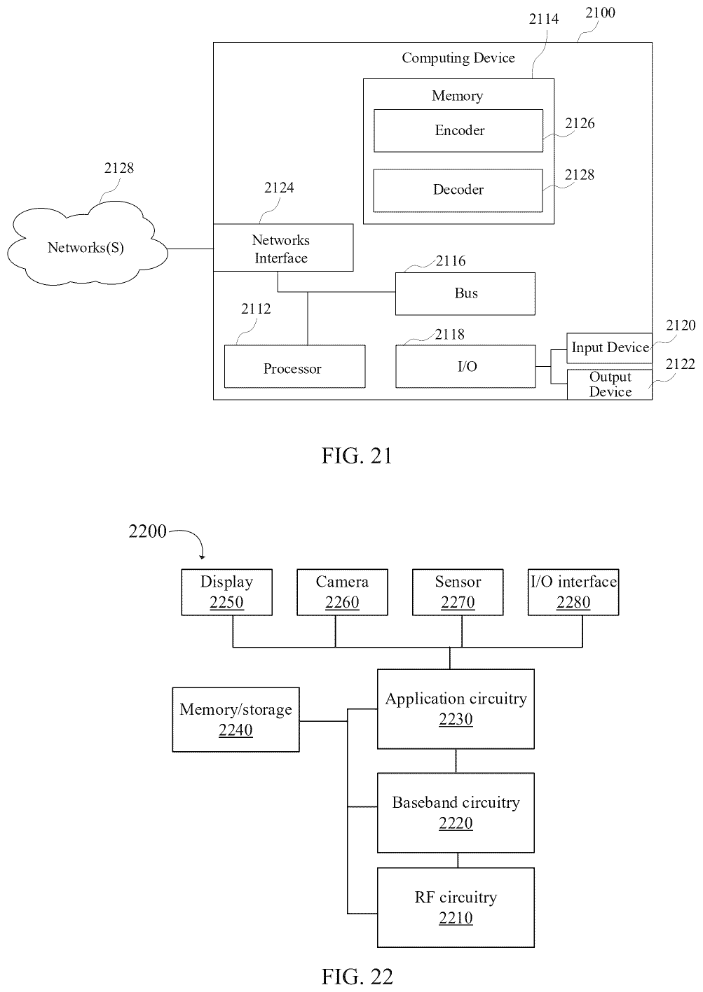

FIG. 21 is an example of a computing device 2100 according to an embodiment of the present disclosure. Any suitable computing device can be used for performing the operations described herein. For example, FIG. 21 illustrates an example of the computing device 2100 that can implement methods, systems, and apparatuses for video coding (including video encoding and/or video decoding) as illustrated in FIGS. 1 to 20 using any suitably configured hardware and/or software. In some embodiments, the computing device 2100 can include a processor 2112 that is communicatively coupled to a memory 2114 and that executes computer-executable program code and/or accesses information stored in the memory 2114. The processor 2112 may include a microprocessor, an application-specific integrated circuit (“ASIC”), a state machine, or other processing device. The processor 2112 can include any of a number of processing devices, including one. Such a processor can include or may be in communication with a computer-readable medium storing instructions that, when executed by the processor 2112, cause the processor to perform the operations described herein.

The memory 2114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 2100 can also include a bus 2116. The bus 2116 can communicatively couple one or more components of the computing device 2100. The computing device 2100 can also include a number of external or internal devices such as input or output devices. For example, the computing device 2100 is illustrated with an input/output (“I/O”) interface 2118 that can receive input from one or more input devices 2120 or provide output to one or more output devices 2122. The one or more input devices 2120 and one or more output devices 2122 can be communicatively coupled to the I/O interface 2118. The communicative coupling can be implemented via any suitable manner (e.g., a connection via a printed circuit board, connection via a cable, communication via wireless transmissions). Non-limiting examples of input devices 2120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1212 include a liquid crystal display (LCD) screen, an external monitor, a speaker, or any other device that can be used to display or otherwise present outputs generated by a computing device.

The computing device 2100 can execute program code that configures the processor 2112 to perform one or more of the operations described above with respect to FIGS. 1-20. The program code can include an encoder 2126 and/or a decoder 2128. The encoder 2126 may be a video encoder or a video encoding device in the above embodiments. The decoder 2128 may be a video decoder or a video decoding device in the above embodiments. The program code may be resident in the memory 2114 or any suitable computer-readable medium and may be executed by the processor 2112 or any other suitable processor.

The computing device 2100 can also include at least one network interface device 2124. The network interface device 2124 can include any device or group of devices suitable for establishing a wired or wireless data connection to one or more data networks 2128. Non limiting examples of the network interface device 2124 include an Ethernet network adapter, a modem, and/or the like. The computing device 2100 can transmit messages as electronic or optical signals via the network interface device 2124.

FIG. 22 is a block diagram of an example of a communication system 2200 according to an embodiment of the present disclosure. Embodiments described herein may be implemented into the communication system 2200 using any suitably configured hardware and/or software. FIG. 22 illustrates the communication system 2200 including a radio frequency (RF) circuitry 2210, a baseband circuitry 2220, an application circuitry 2230, a memory/storage 2240, a display 2250, a camera 2260, a sensor 2270, and an input/output (I/O) interface 2280, coupled with each other at least as illustrated.

The application circuitry 2230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 2200 can execute program code that configures the application circuitry 2230 to perform one or more of the operations described above with respect to FIGS. 1-20. The program code may be resident in the application circuitry 2230 or any suitable computer-readable medium and may be executed by the application circuitry 2230 or any other suitable processor.

The baseband circuitry 2220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 2220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 2210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 2210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to systems and apparatuses for video coding (including video encoding and/or video decoding) as illustrated in the above embodiments in FIGS. 1 to 20 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 2240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 2280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 2270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 2250 may include a display, such as a liquid crystal display and a touch screen display. In various embodiments, the communication system 2200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A prediction method applied to a video decoder, comprising:
decoding an intra prediction mode from a bitstream; and
performing an intra fusion prediction of a current block to obtain a prediction block, wherein the intra fusion prediction comprises predicting the current block based on a plurality of reference sample lines and the intra prediction mode.

2. The method of claim 1, wherein enabling the intra fusion prediction in case the intra prediction mode indicates an integer-slope prediction direction.

3. The method of claim 2, wherein enabling the intra fusion prediction in case a width of the current block, a height of the current block, an/or a block size of the current block within a range value based on the plurality of reference sample lines and the intra prediction mode.

4. The method of claim 1, wherein predicting the current block based on the plurality of reference sample lines and the intra prediction mode further comprises:
determining a plurality of prediction blocks by performing prediction based on a plurality of reference sample lines, respectively, such that each prediction block is determined based on each reference sample line, wherein the plurality of reference sample lines are spatially adjacent to each other; and
fusing the plurality of prediction blocks into the current block.

5. The method of claim 4, wherein the plurality of reference sample lines comprises a first reference sample line and a second reference sample line, the method further comprises decoding first information from the bitstream, wherein the first information indicates an index of the first reference sample line.

6. The method of claim 5, wherein if the index is equal to 0, the second reference sample line is a reference sample spatially adjacent to the first reference sample line away from the current block.

7. The method of claim 5, wherein if the index is greater than 0, the second reference sample line is a reference sample spatially adjacent to the first reference sample line near the current block.

8. The method of claim 1, wherein predicting the current block based on the plurality of reference sample lines and the intra prediction mode further comprises:
fusing the plurality of reference sample lines into a fused reference sample line; and
predicting the current block based on the fused reference sample line.

9. The method of claim 1, further comprising:
decoding second information from the bitstream; and
enabling intra fusion prediction for decoding luma component and/or chroma component of the current block based on the second information.

10. The method of claim 9, wherein enabling intra fusion prediction for decoding luma component and/or chroma component of the current block is at at least one level.

11. The method of claim 10, wherein the at least one level comprises a sequence parameter set (SPS) level, a picture header (PH) level, a picture parameter set (PPS) level, and/or a slice header (SH) level.

12. The method of claim 1, wherein the current block comprises a chroma block and/or at least one luma block.

13. A prediction method applied to a video encoder, comprising:
performing an intra fusion prediction of a current block to obtain a prediction block, wherein the intra fusion prediction includes predicting the current block based on a plurality of reference sample lines and an intra prediction mode; and
encoding the intra prediction mode into a bitstream.

14. The method of claim 13, wherein enabling the intra fusion prediction in case the intra prediction mode indicates an integer-slope prediction direction.

15. The method of claim 14, wherein enabling the intra fusion prediction in case a width of the current block, a height of the current block, an/or a block size of the current block within a range value based on the plurality of reference sample lines and the intra prediction mode.

16. The method of claim 13, wherein predicting the current block based on the plurality of reference sample lines and the intra prediction mode further comprises:
determining a plurality of prediction blocks by performing prediction based on a plurality of reference sample lines, respectively, such that each prediction block is determined based on each reference sample line, wherein the plurality of reference sample lines are spatially adjacent to each other; and
fusing the plurality of prediction blocks into the current block.

17-19. (canceled)

20. The method of claim 13, wherein predicting the current block based on the plurality of reference sample lines and the intra prediction mode further comprises:
fusing the plurality of reference sample lines into a fused reference sample line; and
predicting the current block based on the fused reference sample line.

21. The method of claim 13, further comprising:
setting information to indicate enabling of the intra fusion when intra fusion prediction is used; and
encoding the information into the bitstream;
wherein the information is encoded at at least one level.

22-23. (canceled)

24. The method of claim 13, wherein the current block comprises a chroma block and/or at least one luma block.

25. A video decoding device, comprising:
a memory;
a transceiver; and
a processor coupled to the memory and the transceiver;
wherein the processor is configured to perform;
decoding an intra prediction mode from a bitstream; and
performing an intra fusion prediction of a current block to obtain a prediction block, wherein the intra fusion prediction comprises predicting the current block based on a plurality of reference sample lines and the intra prediction mode.

26-31. (canceled)
